(19) United States
(12) Patent Application Publication
(10) Pub. No.: US 2008/0106609 A1
(43) Pub. Date: May 8, 2008

(54) Method and apparatus for taking a moving picture

(75) Inventor: O-hyun Kwon, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/784,362

(22) Filed: Apr. 6, 2007

(30) Foreign Application Priority Data
Nov. 2, 2006 (KR) 10-2006-0107956

(51) Int. Cl. H04N 5/21

(52) U.S. Cl. 348/208.99

(57) ABSTRACT

A method and apparatus for taking a moving picture that quickly and effectively reduces a processor load and stabilizes an image due to shaking of the apparatus. The apparatus and method perform operations for extracting feature points from a k^{th} image captured by the apparatus, extracting feature points from a k+1^{st} image captured by the apparatus, and determining whether the relationship between positions of the feature points of the k^{th} image and positions of the feature points of the k+1^{st} image is a parallel movement relationship. If it is determined that the relationship is the parallel movement relationship, the k^{th} image and/or the k+1^{st} image is moved according to the parallel movement relationship so as to stabilize the moving picture. However, if it is determined that the relationship is not the parallel movement relationship, a spatial movement relationship is calculated between positions of the feature points of the k^{th} image and positions of the feature points of the k+1^{st} image, and the k^{th} image and/or the k+1^{st} image is moved according to the calculated spatial movement relationship so as to stabilize the moving picture.

### BACKGROUND OF THE INVENTION

This application claims the priority of Korean Patent Application No. 10-2006-0107956, filed on Nov. 2, 2006, in the Korean Intellectual Property Office, the disclosure of which is incorporated herein in its entirety by reference.

### FIELD OF THE INVENTION

The present invention relates to a method and apparatus for taking a moving picture. More particularly, the present invention relates to a method and apparatus for taking a moving picture and stabilizing the moving picture to reduce the effect caused by shaking of the apparatus, with reduced processor load.

### DESCRIPTION OF THE RELATED ART

Apparatuses for taking moving pictures are used to photograph a variety of moving subjects. Attempts to improve these apparatuses are being made as the demand for such apparatuses increases. In particular, since a user typically photographs subjects by holding a portable apparatus for taking moving pictures in his or her hands, attempts are being made to stabilize the moving picture to reduce the negative effect caused due to shaking of the apparatus.

FIGS. 1 and 2 are schematic diagrams showing an example of image tremble that can occur when a conventional apparatus for taking a moving picture is used to photograph a subject, and movement occurs during photographing. Referring to FIGS. 1 and 2, even if a subject is photographed when the position of the subject does not actually move, the position of the subject moves in the moving picture since the conventional apparatus is shaking in the person's hands. Since the conventional apparatus in this example is shaking up and down, the position of the subject moves up and down in the photographed moving picture. Therefore, when the photograph of the subject is reproduced, the position of the subject in the moving picture keeps shifting, which can cause a person viewing the moving picture to feel dizzy or nauseous.

In order to address these problems, moving picture stabilization technology has been developed. The moving picture stabilization technology computes the relationship (the distance and direction) between the position of a prominent point of a photographed k^{th} image (a k^{th} frame image) and the position of a k+1^{st} image of the prominent point (a k+1^{st} frame image), and moves the k+1^{st} image in an opposite direction according to the relationship. Therefore, the position of the prominent point of the k^{th} image and the position of the prominent point of the moved k+1^{st} image are identical to each other so that all subjects in the k^{th} image and the moved k+1^{st} image have the same positions. Therefore, even if the conventional apparatus is shaking, when the photographed moving picture is reproduced, the position of the subject remains unchanged in the moving picture.

However, there are a variety of cases where the apparatus moves in a straight line in a plane that is perpendicular to a line connecting a photographer and a subject, the apparatus for taking the moving picture rotates in the plane, the apparatus moves from the inside of the plane to the outside of the plane, and so on. Therefore, if a single algorithm is used to stabilize the moving picture due to the various shaking movements of the apparatus, the single algorithm needs to calculate the relationship between the position of the k^{th} image and the position of the k+1^{st} image according to the various movements, and move the k+1^{st} image according to the relationship. However, since the single algorithm is very complicated, the apparatus employs an expensive processor and a large memory, which increases the cost of the apparatus. Furthermore, if the apparatus experiences large movement or a variety of movements, the processing load imposed on even a costly, state of the art processor greatly increases. Therefore, a complicated moving picture stabilization algorithm cannot be efficiently performed, and effective moving picture stabilization cannot be achieved.

### SUMMARY OF THE INVENTION

An embodiment of the present invention provides a method and apparatus for taking a moving picture that perform operations that quickly and effectively reduce processor load and stabilize the moving image due to shaking of the apparatus for taking the moving picture.

According to an aspect of the present invention, the method and apparatus employ operations for extracting feature points from a k^{th} image captured by the apparatus, extracting feature points from a k+1^{st} image captured by the apparatus, and determining whether the relationship between positions of the feature points of the k^{th} image and positions of the feature points of the k+1^{st} image is a parallel movement relationship. If it is determined that the relationship is the parallel movement relationship, the k^{th} image or the k+1^{st} image are moved according to the parallel movement relationship so as to stabilize the moving picture. However, if it is determined that the relationship is not the parallel movement relationship, a spatial movement relationship between positions of the feature points of the k^{th} image and positions of the feature points of the k+1^{st} image is calculated, and the k^{th} image or the k+1^{st} image is moved according to the calculated spatial movement relationship to stabilize the moving picture.

The operation of extracting of the feature points from the k^{th} image comprises converting the k^{th} image into a black and white image and extracting feature points from the converted k^{th} image. The operation of extracting of the feature points from the k+1^{st} image comprises converting the k+1^{st} image into a black and white image and extracting feature points from the converted k+1^{st} image.

When extracting the feature points from the k^{th} image, if a difference between brightness of a point of the k^{th} image and brightness of an area adjacent to the point is greater than a predetermined difference, then the point is extracted as a feature point. Also, when extracting the feature points from the k+1^{st} image, if a difference between brightness of a point of the k+1^{st} image and brightness of an area adjacent to the point is greater than the predetermined difference, then the point is extracted as a feature point.

In addition, when extracting the feature points from the k^{th} image, if a difference between chroma of a point of the k^{th} image and chroma of an area adjacent to the point is greater than a predetermined difference, then the point is extracted as a feature point. Furthermore, when extracting the feature points from the k+1^{st} image, if a difference between chroma of a point of the k+1^{st} image and chroma of an area adjacent to the point is greater than the predetermined difference, then the point is extracted as a feature point.

The operation of determining of whether the relationship between positions of the feature points of the k^{th} image and positions of the feature points of the k+1^{st} image is the parallel movement relationship includes determining whether the relationship between positions of the feature points of the k^{th} image and positions of the feature points of the k+1^{st} image respectively corresponding to the feature points of the k^{th} image is the parallel movement relationship. The calculating of the spatial movement relationship between positions of the feature points of the k^{th} image and positions of the feature points of the k+1^{st} image includes calculating the spatial movement relationship between positions of the feature points of the k^{th} image and positions of the feature points of the k+1^{st} image respectively corresponding to the feature points of the k^{th} image.

Among the feature points extracted from the k+1^{st} image, a feature point corresponding to a feature point among the feature points extracted from the k^{th} image is selected to be the closest to the feature point extracted from the k^{th} image.

When the directions and distances between the positions of each of the feature points of the k^{th} image and the positions of their corresponding feature points of the k+1^{st} image are the same, the relationship between positions of the feature points of the k^{th} image and positions of the feature points of the k+1^{st} image is determined to be a parallel movement relationship.

The spatial movement relationship is a far-to-near movement relationship or a rotational movement relationship. Also, the spatial movement relationship can be a combination of any of the far-to-near movement relationship, the rotational movement relationship, and the parallel movement relationship.

As can be appreciated from the above, the image is stabilized by moving the k^{th} image and/or the k+1^{st} image according to the type of relationship and making the feature points of the k^{th} image correspond to the feature points of the k+1^{st} image.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 are schematic diagrams showing an example of an image tremble occurring when a conventional apparatus for taking a moving picture is used to photograph a moving subject;

FIG. 3 is a conceptual diagram illustrating an example of the parallel movement relationship between the position of a k^{th} image and the position of a k+1^{st} image due to shaking of an apparatus for taking a moving picture according to an embodiment of the present invention;

FIG. 4 is a conceptual diagram illustrating an example of the rotational movement relationship between the position of a k^{th} image and the position of a k+1^{st} image due to shaking of an apparatus for taking a moving picture according to an embodiment of the present invention;

FIG. 5 is a conceptual diagram illustrating an example of the far-to-near movement relationship between the position of a k^{th} image and the position of a k+1^{st} image due to shaking of an apparatus for taking a moving picture according to an embodiment of the present invention;

FIG. 6 is a conceptual diagram illustrating an example of the rotational movement relationship between the position of a k^{th} image and the position of a k+1^{st} image due to shaking of an apparatus for taking a moving picture according to another embodiment of the present invention;

FIG. 7 is a flowchart illustrating an example of an image stabilization process of a method for controlling an apparatus for taking a moving picture according to an embodiment of the present invention; and

FIG. 8 is a block diagram illustrating an apparatus for taking a moving picture according to an embodiment of the present invention.

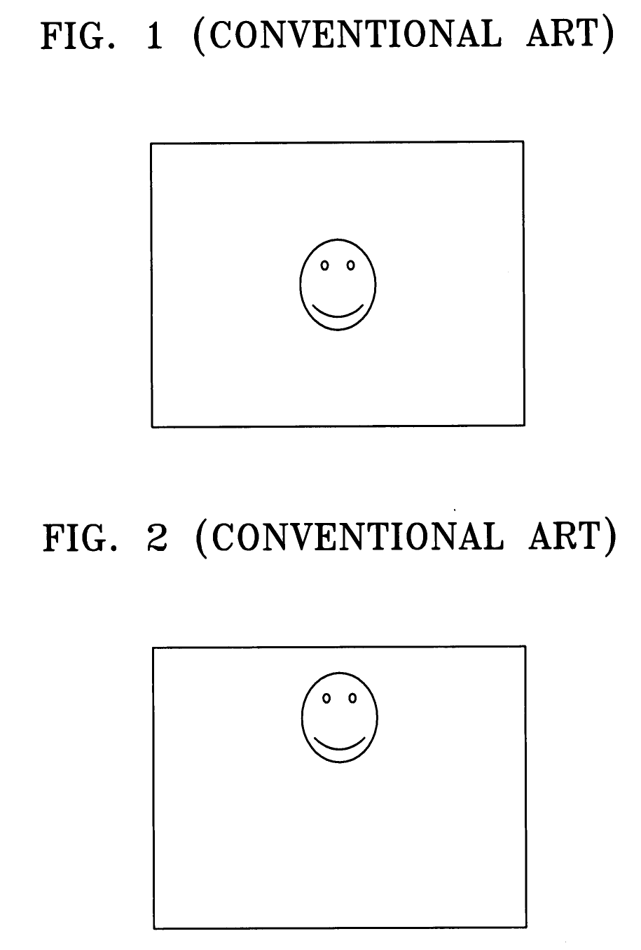

### DETAILED DESCRIPTION OF THE EMBODIMENTS

Embodiments of the present invention will now be described more fully with reference to the accompanying drawings.

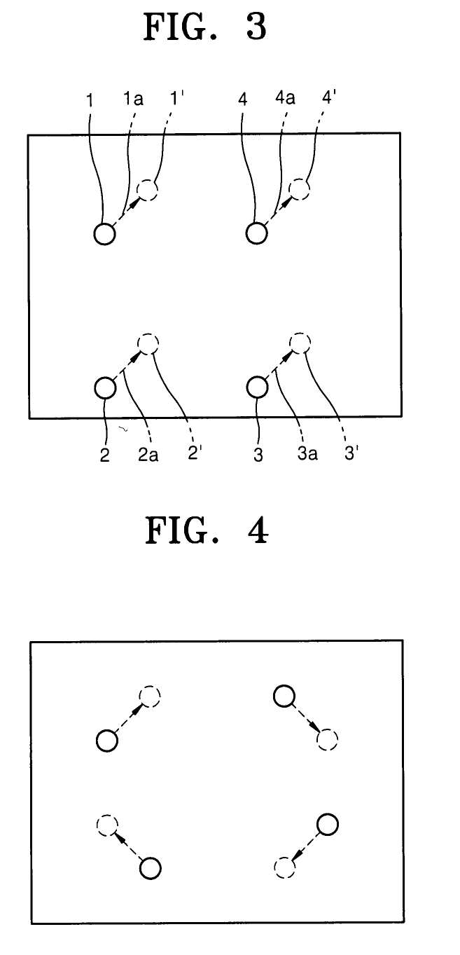

FIG. 3 is a conceptual diagram of the parallel movement relationship between the position of a k^{th} image and the position of a k+1^{st} image due to shaking of an apparatus for taking a moving picture according to an embodiment of the present invention. Referring to FIG. 3, solid-lined circles 1, 2, 3, and 4 are feature points of the k^{th} image (a k^{th} frame image), and dotted-lined circles 1′, 2′, 3′, and 4′ are feature points of the k^{th} image in the k+1^{st} image (a k+1^{st} frame image). Arrows 1a, 2a, 3a, and 4a indicate the relationship (direction and distance) between positions of the feature points of the k^{th} image and positions of the feature points of the k+1^{st} image.

The feature points are prominent points that can be extracted using various methods. For example, if a difference between the brightness of a point of the k^{th} image and brightness of an area adjacent to the point is greater than a predetermined difference, the point can be a feature point. Since the brightness of the point is similarly greater than the brightness of an area adjacent to the point of the k+1^{st} image by the predetermined difference, the point can be extracted as the feature point of the k+1^{st} image. The predetermined difference used to extract the feature point can be modified as occasions demand. For example, when many points greatly differ from their respective adjacent areas in terms of brightness, the predetermined difference is increased in order to appropriately reduce the number of feature points, and when a few points greatly differ from their respective adjacent areas in terms of brightness, the predetermined difference is reduced in order to appropriately increase the number of feature points.

The feature point can be extracted using a variety of references including a difference in chroma. For example, if a difference between chroma of a point of the k^{th} image and chroma of an area adjacent to the point is greater than a predetermined difference, the point can be a feature point. If feature points are extracted based on the difference in brightness, the k^{th} image is converted into a black and white image and feature points are extracted from the converted k^{th} image.

Feature points extracted from the k^{th} image and feature points extracted from the k+1^{st} image correspond to each other. For example, if a difference between the brightness of a point of the k^{th} image and the brightness of an area adjacent to the point is greater than a predetermined difference, and the point is a feature point, since the brightness of the point is similarly greater than the brightness of an area adjacent to the point of the k+1^{st} image by the predetermined difference, the point is extracted as the feature point of the k+1^{st} image. Therefore, feature points extracted from the k^{th} image correspond to feature points extracted from the k+1^{st} image, respectively. Among the feature points extracted from the k+1^{st} image, a feature point corresponding to a feature point among the feature points extracted from the k^{th} image is selected to be the closest to the feature point extracted from the k^{th} image. Among the feature points 1′, 2′, 3′, and 4′ extracted from the k+1^{st} image, since the feature point 1′ is the closest_to the feature point 1 extracted from the k^{th} image, the feature point 1′ extracted from the k+1^{st} image corresponds to the feature point 1 extracted from the k^{th} image. Although the position of a subject in each frame image (the k^{th} image and the k+1^{st} image) changes due to shaking of the apparatus, the position of the subject does not rapidly change in each captured frame image.

In the example shown in FIG. 3, the apparatus for taking the moving picture moves in the opposite direction of the arrows 1a, 2a, 3a, and 4a, and in particular, in a straight line (in the opposite direction of the arrows 1a, 2a, 3a, and 4a) in a plane that is perpendicular to a line connecting a photographer and the subject. In this case, the arrows 1a, 2a, 3a, and 4a have the same length and direction. That is, when the directions and distances between the positions of the feature points of the k^{th} image and the positions of each of the corresponding feature points of the k+1^{st} image are the same, the relationship between positions of the feature points of the k^{th} image and positions of the feature points of the k+1^{st} image is the parallel movement relationship.

The fact that the relationship between positions of the feature points of the k^{th} image and positions of the feature points of the k+1^{st} image is a parallel movement relationship indicates that the relationship between the position of the k^{th} image and the position of the k+1^{st} image is the parallel movement relationship. In order to stabilize the moving picture, the k^{th} image and/or the k+1^{st} image is moved according to a calculated parallel movement relationship to make the feature points of the k^{th} image correspond to the feature points of the k+1^{st} image. For example, the image is stabilized by moving the k+1^{st} image by the length of the arrows 1a, 2a, 3a, and 4a in the opposite direction of the arrows 1a, 2a, 3a, and 4a.

It is easier to determine whether the k^{th} image and the k+1^{st} image have the parallel movement relationship and convert the k+1^{st} image for the moving picture stabilization according to the determination than to do the same for other relationships that will be described below. Therefore, the moving picture stabilization based on the parallel movement relationship does not produce excessive processor load, and can be quickly completed using a memory having limited storage.

FIG. 4 is a conceptual diagram illustrating an example of the rotational movement relationship between the position of a k^{th} image and the position of a k+1^{st} image due to shaking of an apparatus for taking a moving picture according to an embodiment of the present invention. In particular, the rotational movement relationship is based on the rotation around the center of an image.

Referring to FIG. 4, the apparatus rotates counterclockwise, in particular, around a line (axis) connecting a photographer and a subject. In this case, the k^{th} image and the k+1^{st} image rotate around the center of the image, and the arrows have the same length but different directions.

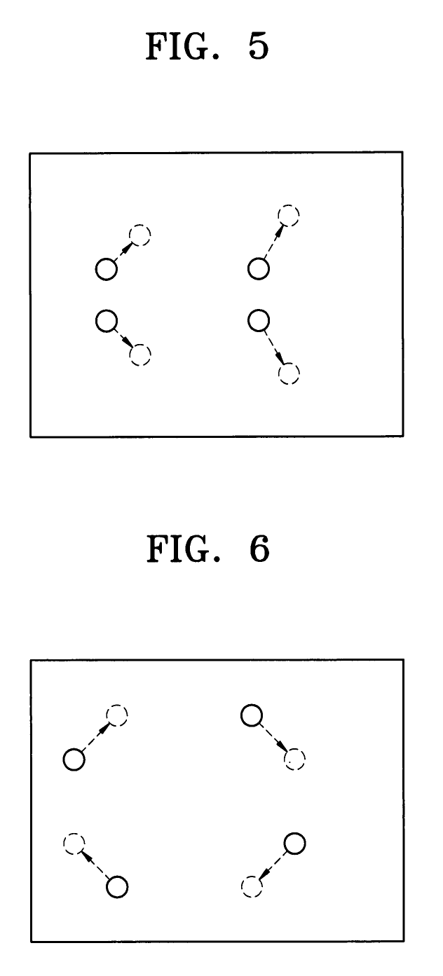

FIG. 5 is a conceptual diagram illustrating an example of the far-to-near movement relationship between the position of a k^{th} image and the position of a k+1^{st} image due to shaking of an apparatus for taking a moving picture according to an embodiment of the present invention. Referring to FIG. 5, the apparatus does not move in a plane that is perpendicular to a line connecting a photographer and a subject, but instead moves to the outside of the plane. That is, when the apparatus approaches the subject, a right part of the apparatus approaches the subject more closely than a left part of the apparatus. Two left arrows indicating the relationship between positions of two left feature points have the same length but different directions. Two right arrows indicating the relationship between positions of two right feature points also have the same length but different directions, and the left two arrows and the right two arrows have different lengths.

FIG. 6 is a conceptual diagram illustrating an example of the rotational movement relationship between the position of a k^{th} image and the position of a k+1^{st} image due to shaking of an apparatus for taking the moving picture according to another embodiment of the present invention. As can be appreciated, FIGS. 4 and 6 illustrate movement that are similar to each other in terms of the shaking of the apparatus, but are different from each other in terms of the center of rotation.

As described above, the apparatus can shake or move in various ways. As will now be described, according to an embodiment of the present invention, the moving picture can be effectively stabilized and the processor load can be considerably reduced.

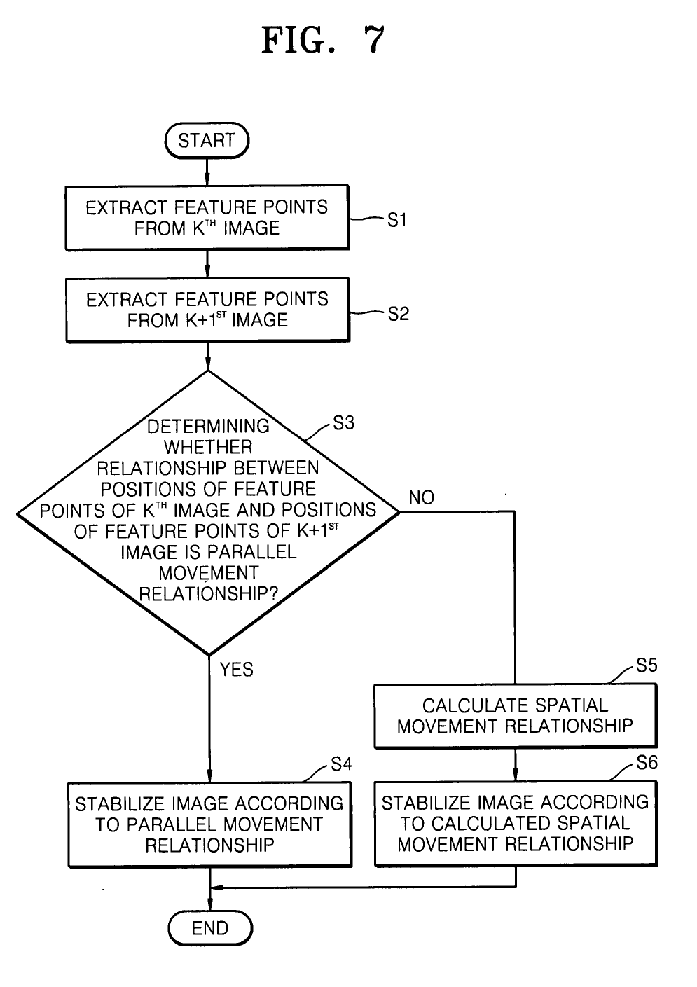

FIG. 7 is a flowchart illustrating an example of an image stabilization process of the method of controlling the apparatus for taking a moving picture according to an embodiment of the present invention. Referring to FIG. 7, feature points are extracted from a k^{th} image (Operation S1) and feature points are extracted from a k+1^{st} image (Operation S2). It is then determined whether the relationship between positions of the feature points of the k^{th} image and positions of the feature points of the k+1^{st} image is the parallel movement relationship (Operation S3). It is relatively easier to determine whether the relationship is the parallel movement relationship than whether the relationship is another relationship, which does not produce the processor load. If it is determined that the relationship is the parallel movement relationship, the k^{th} image and/or the k+1^{st} image is moved so as to stabilize the moving picture according to the parallel movement relationship (Operation S4). However, if it is determined that the relationship is not the parallel movement relationship, the spatial movement relationship between positions of the feature points of the k^{th} image and positions of the feature points of the k+1^{st} image is calculated (Operation S5). The k^{th} image and/or the k+1^{st} image is moved so as to stabilize the moving picture according to the calculated spatial movement relationship (Operation S6). The spatial movement relationship can be the rotational movement relationship illustrated in FIGS. 4 and 6, the far-to-near movement relationship illustrated in FIG. 5, or a combination of any of the far-to-near movement relationship and the rotational movement relationship, and the parallel movement relationship.

The probability that the relationship between positions of the feature points of the k^{th} image and positions of the feature points of the k+1^{st} image is the parallel movement relationship is much higher than the probability that the relationship is another relationship (the spatial movement relationship). Therefore, the method of controlling the apparatus for taking the moving picture of the present embodiment can considerably reduce the amount of processor load since it first determines whether the relationship between positions of the feature points of the k^{th} image and positions of the feature points of the k+1^{st} image is the parallel movement relationship. If it is determined that the relationship is not the parallel movement relationship, the spatial movement relationship producing a larger amount of processor load is calculated, and the moving picture is stabilized according to the spatial movement relationship.

As discussed above, it is easier to determine whether the relationship is the parallel movement relationship illustrated in FIG. 3, which does not produce significant processor load. If changes between positions of the feature points of the k^{th} image and positions of the feature points of the k+1^{st} image have the same size and direction, since the relationship is the parallel movement relationship, no further relationship between the changes need be calculated. Since it is easy to determine whether the relationship is the parallel movement relationship, if it is determined that the relationship is not the parallel movement relationship, it can be thus be easily determined that the relationship is another relationship. However, a more complicated algorithm is required to determine the specific relationship. Furthermore, another complicated algorithm is used to convert one of the k^{th} image and the k+1^{st} image and stabilize the image according to the determined relationship.

For example, if the relationship between positions of n feature points extracted from the k^{th} image and positions of n feature points extracted from the k+1^{st} image is the parallel movement relationship, the relationship between a feature point of the k^{th} image and a feature point of k+1^{st} image corresponding to the feature point of the k^{th} image is a 2×2 matrix that is correspondingly applied to all the n feature points extracted from the k^{th} image and all the n feature points extracted from the k+1^{st} image respectively corresponding to the n feature points extracted from the k^{th} image. Although n feature points are extracted from the k^{th} image and n feature points are extracted from the k+1^{st} image, the matrix can be easily calculated from the relationship between positions of two feature points of the k^{th} image and positions of two feature points of the k+1^{st} image corresponding to the two feature points of the k^{th} image by using first degree simultaneous equations having two unknowns. For example, if feature points having coordinates of (1,2) and (2,2) of the k^{th} image are feature points having coordinates of (2,4) and (3,4) of the k+1^{st} image, a matrix indicating the parallel movement relationship is expressed by the following equation:

$$( \begin{matrix}1 & 0.5 \\ 0 & 2\end{matrix} ) \qquad [ Equation 1 ]$$

However, in the case of the spatial movement relationship other than the parallel movement relationship, matrices such as 3×9, 2×9, and the like appear, and a complicated calculation such as a special equation of multiple degrees and unknowns is repeatedly carried out. An example of a calculation of the spatial movement relationship that can be used is described in a book by Hartley and Zisserman entitled Multiple View Geometry, Cambridge, (2nd edition, 2003), pp 88-91, incorporated by reference herein.

Therefore, according to an embodiment of the present embodiment, it is determined whether the relationship between positions of feature points of the k^{th} image and positions of feature points of the k+1^{st} image, i.e., the relationship between the position the k^{th} image and the position of the k+1^{st} image, is the parallel movement relationship. If it is determined that the relationship is the parallel movement relationship, the moving picture is stabilized according to the parallel movement relationship, which does not produce significant processor load. If it is determined that the relationship is not the parallel movement relationship, the spatial movement relationship between positions of the feature points of the k^{th} image and positions of the feature points of the k+1^{st} image is calculated in order to stabilize the moving picture, which reduces the amount of processor load, thereby considerably stabilizing the moving picture while allowing the use of an inexpensive processor.

In addition, as can be appreciated, when a user photographs a subject by holding the apparatus in his or her hands, the probability that the shaking of the apparatus for taking the moving picture corresponds to the parallel movement relationship is relatively higher than the probability that it corresponds to another relationship. The reasons for this are as follows.

First, considering a plane that is perpendicular to a line connecting the subject and a photographer, and more specifically, that is perpendicular to the subject and the apparatus, the probability of a change in the image made when the apparatus moves inside the plane is higher than that when the apparatus moves from the inside of the plane to the outside of the plane. This is because the distance between the subject and the apparatus is usually much longer than the size of the apparatus. That is, since the distance between the subject and the apparatus is much longer than the size of the apparatus, a change in the distance between the subject and the apparatus, i.e., the probability of the change in the image made when the moves from the inside of the plane that is perpendicular to the line connecting the subject and the apparatus to the outside of the plane, is very small.

Second, when the apparatus moves in the plane that is perpendicular to the line connecting the subject and the apparatus, and the photographer photographs the subject by holding the apparatus in his or her hands, the probability of the rotation of the apparatus in the plane is relatively higher than that of the movement of the apparatus in a straight line inside the plane. The photographer usually holds the apparatus in one of his or her hands, or does not use his or her other hands except supplementarily. Therefore, a photographer's wrist can become twisted, or the photographer's upper body can rotate in order to rotate the apparatus, thus causing the shaking of the apparatus. In other cases, the apparatus does not rotate but moves in the straight line.

In view of the above two reasons, the probability that the shaking of the apparatus corresponds to the parallel movement relationship illustrated in FIG. 3 is higher than the probability that it corresponds to the other relationships illustrated in FIGS. 4 through 6. Therefore, it is determined whether the relationship between positions of feature points of the k^{th} image and positions of feature points of the k+1^{st} image, i.e., the relationship between the position of the k^{th} image and the position of the k+1^{st} image, is the parallel movement relationship. If it is determined that the relationship is not the parallel movement relationship, the spatial movement relationship is calculated, thereby considerably reducing the calculation of the spatial movement relationship that produces a great amount of processor load in the conventional method of controlling the apparatus discussed in the Background section above.

Accordingly, as can be appreciated from the above, the method and apparatus for taking a moving picture according to embodiments of the present invention can quickly and effectively stabilize any undesired movement in the moving picture that is caused by shaking of the apparatus and reduce processor load. The moving picture can thus be effectively stabilized using an inexpensive processor and memory having limited storage, thereby reducing the manufacturing cost of the apparatus.

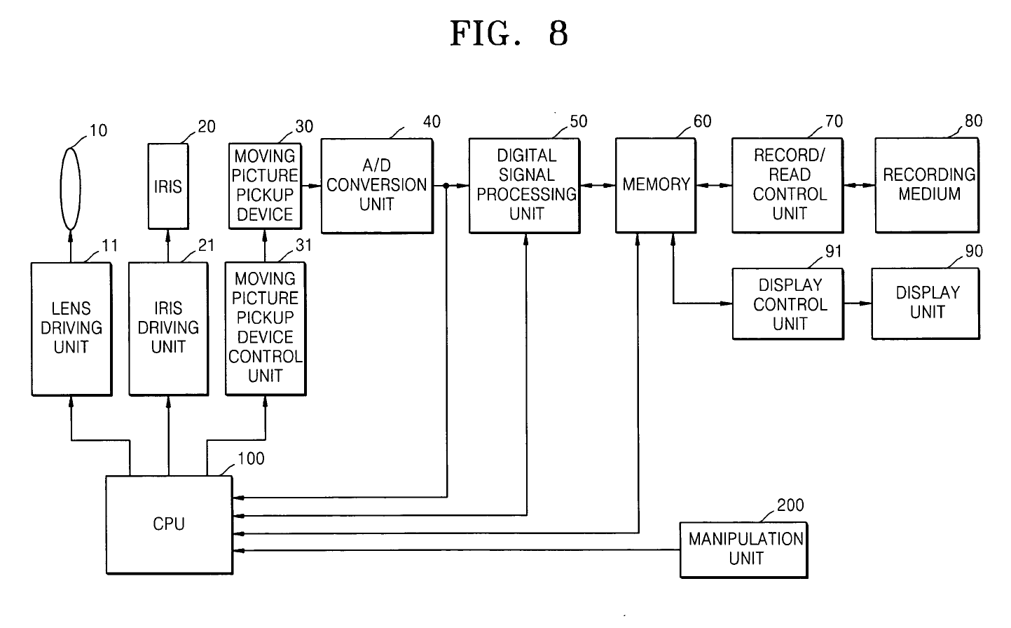

FIG. 8 is a block diagram illustrating an apparatus for taking a moving picture according to an embodiment of the present invention.

The entire operation of the apparatus is controlled by a CPU 100. A manipulation unit 200, including a key generating an electrical signal from a user, is included in the apparatus. An electrical signal from the manipulation unit 200 is transferred to the CPU 100 such that the CPU 100 can control the apparatus according to the electrical signal.

In a moving picture taking mode, if an electrical signal from the user is transferred to the CPU 100, the CPU 100 identifies the signal and controls a lens driving unit 11, an iris driving unit 21, and a moving picture pickup device control unit 31. According to this control, the position of a lens 10, opening of the iris 20, and sensitivity of a moving picture pickup device 30 are controlled for autofocusing. If a data signal of a moving picture is output from the moving picture pickup device 30, the signal is converted into digital moving picture data by an analog-to-digital (A/D) conversion unit 40, and input to the CPU 100 and a digital signal processing unit 50. The digital signal processing unit 50 performs digital signal processing, such as gamma correction and white balance adjustment.

The moving picture data output from the digital signal processing unit 50 is transferred through a memory 60 or directly to a display control unit 91. Here, the memory 60 includes a read-only memory (ROM) or a random-access memory (RAM). The display control unit 91 controls a display unit 90 and displays a moving picture on the display unit 90. The moving picture data output from the digital signal processing unit 50 can be input to a recording/reading control unit 70 through the memory 60. The recording/reading control unit 70 records the moving picture data on a recording medium 80 automatically or according to a command from the user. Also, the recording/reading control unit 70 can read moving picture data of a moving picture file stored in the recording medium 80, and input the read moving picture data to the display control unit 91 so that the moving picture can be displayed on the display unit 90.

A program for executing the control method of the apparatus for taking a moving picture according to the embodiments and variations of present invention can be stored in a recording medium, i.e., a computer readable medium.

The recording medium storing the control method of the apparatus may be the recording medium 80 or the memory 60 as illustrated in FIG. 8, or may also be a separate recording medium. Examples of the recording medium include magnetic storage medium (for example, read-only memory (ROM), and hard disks) and optical data storage devices (for example, CD-ROM, digital versatile disc (DVD)). Also, the CPU 100 illustrated in FIG. 6 or part of the CPU 100 may be employed as the recording medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for controlling an apparatus for taking a moving picture, the method comprising:
extracting feature points from a k^{th} image captured by the apparatus;
extracting feature points from a k+1^{st} image captured by the apparatus;
determining whether the relationship between positions of the feature points of the k^{th} image and positions of the feature points of the k+1^{st} image is a parallel movement relationship;
if it is determined that the relationship is the parallel movement relationship, moving at least one of the k^{th} image and the k+1^{st} image according to the parallel movement relationship so as to stabilize the moving picture; and
if it is determined that the relationship is not the parallel movement relationship, calculating a spatial movement relationship between positions of the feature points of the k^{th} image and positions of the feature points of the k+1^{st} image, moving as least one of the k^{th} image and the k+1^{st} image according to the calculated spatial movement relationship to stabilize the moving picture.

2. The method of claim 1, wherein
the extracting of the feature points from the k^{th} image comprises:
converting the k^{th} image into a black and white image and extracting feature points from the converted k^{th} image, and
wherein the extracting of the feature points from the k+1^{st} image comprises:
converting the k+1^{st} image into a black and white image and extracting feature points from the converted k+1^{st} image.

3. The method of claim 1, wherein
the extracting of the feature points from the k^{th} image comprises:
if a difference between brightness of a point of the k^{th} image and brightness of an area adjacent to the point is greater than a predetermined difference, extracting the point as a feature point, and
wherein the extracting of the feature points from the k+1^{st} image comprises:
if a difference between brightness of a point of the k+1^{st} image and brightness of an area adjacent to the point is greater than the predetermined difference, extracting the point as a feature point.

4. The method of claim 1, wherein
the extracting of the feature points from the k^{th} image comprises:
if a difference between chroma of a point of the k^{th} image and chroma of an area adjacent to the point is greater than a predetermined difference, extracting the point as a feature point, and
wherein the extracting of the feature points from the k+1^{st} image comprises:
if a difference between chroma of a point of the k+1^{st} image and chroma of an area adjacent to the point is greater than the predetermined difference, extracting the point as a feature point.

5. The method of claim 1, wherein
the determining of whether the relationship between positions of the feature points of the k^{th} image and positions of the feature points of the k+1^{st} image is the parallel movement relationship comprises:
determining whether the relationship between positions of the feature points of the k^{th} image and positions of the feature points of the k+1^{st} image respectively corresponding to the feature points of the k^{th} image is the parallel movement relationship, and
wherein the calculating of the spatial movement relationship between positions of the feature points of the k^{th} image and positions of the feature points of the k+1^{st} image comprises:
calculating the spatial movement relationship between positions of the feature points of the k^{th} image and positions of the feature points of the k+1^{st} image respectively corresponding to the feature points of the k^{th} image.

6. The method of claim 1, wherein among the feature points extracted from the k+1^{st} image, a feature point corresponding to a feature point among the feature points extracted from the k^{th} image is selected to be the closest to the feature point extracted from the k^{th} image.

7. The method of claim 1, wherein when directions and distances in the relationship between positions of the feature points of the k^{th} image and positions of the feature points of the k+1^{st} image are the same, the determining step determines the relationship between positions of the feature points of the k^{th} image and positions of the feature points of the k+1^{st} image as the parallel movement relationship.

8. The method of claim 1, wherein the spatial movement relationship is a far-to-near movement relationship or a rotational movement relationship.

9. The method of claim 1, wherein the spatial movement relationship is a combination of one of the far-to-near movement relationship and the rotational movement relationship, and the parallel movement relationship.

10. The method of claim 1, wherein the image is stabilized by moving the k^{th} image or the k+1^{st} image according to the type of relationship and making the feature points of the k^{th} image correspond to the feature points of the k+1^{st} image.

11. A computer-readable medium of instructions for controlling an apparatus for taking a moving picture, the computer-readable medium of instructions comprising:
a first set of instructions operating to extract feature points from a k^{th} image captured by the apparatus;
a second set of instructions operating to extract feature points from a k+1^{st} image captured by the apparatus; and
a third set of instructions operating to determine whether the relationship between positions of the feature points of the k^{th} image and positions of the feature points of the k+1^{st} image is a parallel movement relationship, such that
if it is determined that the relationship is the parallel movement relationship, at least one of the k^{th} image and the k+1^{st} image is moved according to the parallel movement relationship so as to stabilize the moving picture; and
if it is determined that the relationship is not the parallel movement relationship, calculating a spatial movement relationship between positions of the feature points of the k^{th} image and positions of the feature points of the k+1^{st} image, at least one of the k^{th} image and the k+1^{st} image is moved according to the calculated spatial movement relationship to stabilize the moving picture.

12. The computer-readable medium of instructions of claim 11, wherein
the first set of instructions operates to convert the k^{th} image into a black and white image and extract feature points from the converted k^{th} image; and
the second set of instructions operates to convert the k+1^{st} image into a black and white image and extract feature points from the converted k+1^{st} image.

13. The computer-readable medium of instructions of claim 11, wherein
the first set of instructions operates such that if a difference between brightness of a point of the k^{th} image and brightness of an area adjacent to the point is greater than a predetermined difference, the point is extracted as a feature point; and
the second set of operates such that if a difference between brightness of a point of the k+1^{st} image and brightness of an area adjacent to the point is greater than the predetermined difference, the point is extracted as a feature point.

14. The computer-readable medium of instructions of claim 11, wherein
the first set of instructions operates such that if a difference between chroma of a point of the k^{th} image and chroma of an area adjacent to the point is greater than a predetermined difference, the point is extracted as a feature point; and
the second set of instructions operates such that if a difference between chroma of a point of the k+1^{st} image and chroma of an area adjacent to the point is greater than the predetermined difference, the point is extracted as a feature point.

15. The computer-readable medium of instructions of claim 11, wherein
the third set of instructions determines whether the relationship between positions of the feature points of the k^{th} image and positions of the feature points of the k+1^{st} image is the parallel movement relationship by determining whether the relationship between positions of the feature points of the k^{th} image and positions of the feature points of the k+1^{st} image respectively corresponding to the feature points of the k^{th} image is the parallel movement relationship; and
the third set of instructions calculates the spatial movement relationship between positions of the feature points of the k^{th} image and positions of the feature points of the k+1^{st} image by calculating the spatial movement relationship between positions of the feature points of the k^{th} image and positions of the feature points of the k+1^{st} image respectively corresponding to the feature points of the k^{th} image.

16. The computer-readable medium of instructions of claim 11, wherein among the feature points extracted from the k+1^{st} image, a feature point corresponding to a feature point among the feature points extracted from the k^{th} image is selected to be closest to the feature point extracted from the k^{th} image.

17. The computer-readable medium of instructions of claim 11, wherein when the third set of instructions determines that directions and distances in the relationship between positions of the feature points of the k^{th} image and positions of the feature points of the k+1^{st} image are the same, the third set of instructions determines the relationship between positions of the feature points of the k^{th} image and positions of the feature points of the k+1^{st} image to be the parallel movement relationship.

18. The computer-readable medium of instructions of claim 11, wherein the spatial movement relationship is a far-to-near movement relationship or a rotational movement relationship.

19. The computer-readable medium of instructions of claim 11, wherein the spatial movement relationship is a combination of one of the far-to-near movement relationship and the rotational movement relationship, and the parallel movement relationship.

20. The computer-readable medium of instructions of claim 11, wherein the image is stabilized by moving the k^{th} image or the k+1^{st} image according to the type of relationship and making the feature points of the k^{th} image correspond to the feature points of the k+1^{st} image.
